(19) United States
(12) Patent Application Publication
(10) Pub. No.: US 2016/0292489 A1
(43) Pub. Date: Oct. 6, 2016

(54) FINGERPRINT SENSOR AND SENSING METHOD THEREOF

(71) Applicant: Egis Technology Inc., Taipei (TW)

(72) Inventor: Todd Lin, Taipei (TW)

(21) Appl. No.: 14/817,149

(22) Filed: Aug. 3, 2015

(30) Foreign Application Priority Data
Apr. 2, 2015 (CN) 201510154446.4

(51) Int. Cl. G06K 9/00

(52) U.S. Cl. CPC G06K 9/0008; G06K 9/0002

(57) ABSTRACT

A fingerprint sensor is provided for sensing fingerprint information of a finger. The fingerprint sensor includes a sensing array, an insulating surface disposed on the sensing array, a readout module, and a processor. The sensing array includes a plurality of sensing units disposed in a plurality of row lines and a plurality of column lines, wherein each of the sensing units includes a sensing electrode. The transmitting electrode transmits a modulating signal. The readout module obtaining a sensing voltage corresponding to the modulating signal coupled to a finger of the user via the sensing electrode of the sensing unit when the user places the finger on the insulating surface and the modulating signal transmitted by the transmitting electrode is coupled to the finger of the user. The processor obtains the fingerprint information according to the sensing voltage.

### CROSS REFERENCE TO RELATED APPLICATIONS

This Application claims priority of China Patent Application No. 201510154446.4, filed on Apr. 2, 2015, the entirety of which is incorporated by reference herein.

### BACKGROUND OF THE INVENTION

1. Field of the Invention

The invention relates to a fingerprint sensor, and more particularly to a fingerprint sensor with noise immunity.

2. Description of the Related Art

In recent years, biological identification technology has become increasingly mature, and different biological features can be used for identifying users. Since the recognition rate and accuracy of fingerprint identification technology are better than those of other biological feature identification technologies, fingerprint identification and verification are used extensively in various areas.

Fingerprint identification and verification technology detects a user's fingerprint pattern, captures fingerprint data from the fingerprint pattern, and saves the fingerprint data as a template. Thereafter, the user presses or slides the finger on or over the fingerprint sensor so that a fingerprint is captured and compared with the template. If the two match, then the user's identity is verified.

### BRIEF SUMMARY OF THE INVENTION

A fingerprint sensor and a sensing method thereof are provided. An embodiment of a fingerprint sensor is provided for sensing fingerprint information of a finger. The fingerprint sensor includes a sensing array, an insulating surface disposed on the sensing array, a readout module, and a processor. The sensing array comprises a plurality of sensing units disposed in a plurality of row lines and a plurality of column lines, wherein each of the sensing units comprises a sensing electrode. The transmitting electrode transmits a modulating signal. The readout module obtaining a sensing voltage corresponding to the modulating signal coupled to a finger of the user via the sensing electrode of the sensing unit when the user places the finger on the insulating surface and the modulating signal transmitted by the transmitting electrode is coupled to the finger of the user. The processor obtains the fingerprint information according to the sensing voltage.

Furthermore, an embodiment of a sensing method for a fingerprint sensor is provided, wherein the fingerprint sensor comprises a sensing array having a plurality of sensing units disposed in a plurality of row lines and a plurality of column lines, and each of the sensing units comprises a sensing electrode. A modulating signal is transmitted via at least one transmitting electrode of the fingerprint sensor. A sensing voltage corresponding to the modulating signal coupled to a finger of a user is obtained via the sensing electrode of the sensing unit when the user places the finger on the insulating surface and the modulating signal transmitted by the transmitting electrode is coupled to the finger of the user. Fingerprint information is obtained according to the sensing voltage.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 shows a fingerprint sensor according to an embodiment of the invention;

FIG. 2 shows a schematic diagram illustrating that the fingerprint sensor of FIG. 1 is used to obtain the fingerprint of the user;

FIG. 3 shows a sensing array according to an embodiment of the invention;

FIG. 4 shows a sectional schematic illustrating the finger of the user contacting the fingerprint sensor of FIG. 1;

FIG. 5 shows a sensing array according to another embodiment of the invention;

FIG. 6 shows a sensing array according to another embodiment of the invention;

FIG. 7 shows a signal processing unit according to an embodiment of the invention; and

FIG. 8 shows a signal waveform of the signal processing unit of FIG. 7.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

When a user presses or slides his or her finger on or over a fingerprint sensor, the fingerprint sensor will provide the transmitting signal to the user's finger via the transmitting electrode, so as to sense the ridges and the valleys of the fingerprint by detecting the transmitting signal coupled to the finger, and generate different capacitance values corresponding to the ridges and valleys. Next, voltage values corresponding to the capacitance values are obtained by using a charge-sharing technique, and the voltage value is converted into a digital code. The digital code is provided to a processor for subsequent operation and fingerprint identification.

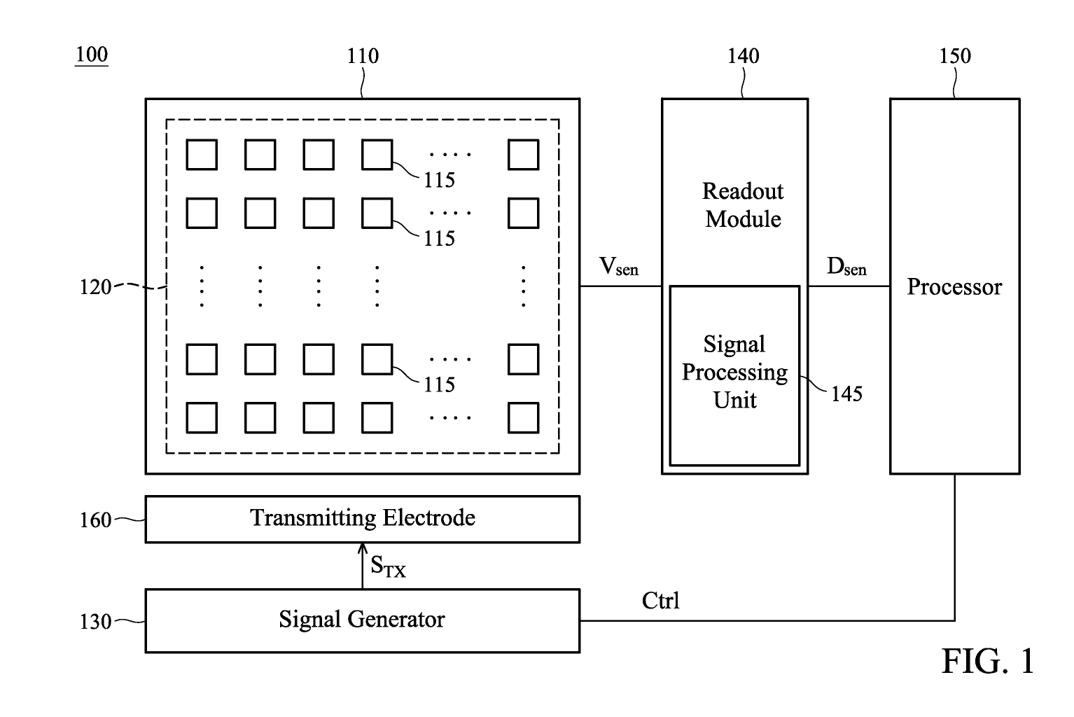

FIG. 1 shows a fingerprint sensor 100 according to an embodiment of the invention. The fingerprint sensor 100 comprises a sensing array 110, an insulating surface 120, a signal generator 130, a readout module 140, a processor 150 and a transmitting electrode 160. The sensing array 110 is formed by a plurality of sensing units 115 arranged in a two-dimensional manner, wherein the insulating surface 120 overlays the whole sensing units 115 of the sensing array 110. First, the processor 150 provides a control signal Ctrl to the signal generator 130, so as to control the signal generator 130 to provide a high frequency transmitting signal S_{TX} to the transmitting electrode 160. In one embodiment, the signal generator 130 is a signal modulator, and the transmitting signal S_{TX} may be a frequency modulation (FM) signal or an amplitude modulation (AM) signal. In another embodiment, the signal generator 130 is a pulse generator, and the transmitting signal S_{TX} may be a pulse signal. When the signal generator 130 provides the transmitting signal S_{TX} to drive the transmitting electrode 160, the transmitting electrode 160 can transmit the transmitting signal S_{TX} to a finger of a user, and the sensing array 110 can detect the transmitting signal S_{TX} coupled to the user's finger. The readout module 140 can obtain a sensing voltage Vₛₑₙ from the sensing array 110, wherein the sensing voltage Vₛₑₙ is provided by the sensing unit 115 to be sensed in the sensing array 110. The readout module 140 comprises a signal processing unit 145, wherein the signal processing unit 145 provides a sensing output Dₛₑₙ to the processor 150 according to the received sensing voltage Vₛₑₙ. In one embodiment, the signal processing unit 145 is a filter capable of filtering the sensing voltage Vₛₑₙ, thus the readout module 140 can provide the sensing output Dₛₑₙ according to the filtered sensing voltage Vₛₑₙ. For example, when the fingerprint sensor 100 is subjected to interference, the signal processing unit 145 can filter the received sensing voltage Vₛₑₙ and filter out the noise, thereby increasing the recognition of the sensing voltage Vₛₑₙ for the readout module 140. Furthermore, when the transmitting signal S_{TX} is a FM signal or an AM signal, the transmitting signal S_{TX} has better noise immunity. In another embodiment, the signal processing unit 145 is an integrator capable of integrating the sensing voltage Vₛₑₙ, thus the readout module 140 can provide the sensing output Dₛₑₙ according to the integrated sensing voltage Vₛₑₙ. After obtaining the sensing output Dₛₑₙ of the sensing unit 115, the processor 150 determines whether the user's finger is in contact with the insulating surface 120, and further obtains fingerprint information of the finger, so as to determine that the sensing output Dₛₑₙ corresponds to a fingerprint ridge or a fingerprint valley of the finger. Thus, according to the sensing outputs Dₛₑₙ of all sensing units 115, the processor 150 obtains the binary or gray-level fingerprint data for subsequent processes, for example, a fingerprint identification operation is performed by a fingerprint identification algorithm.

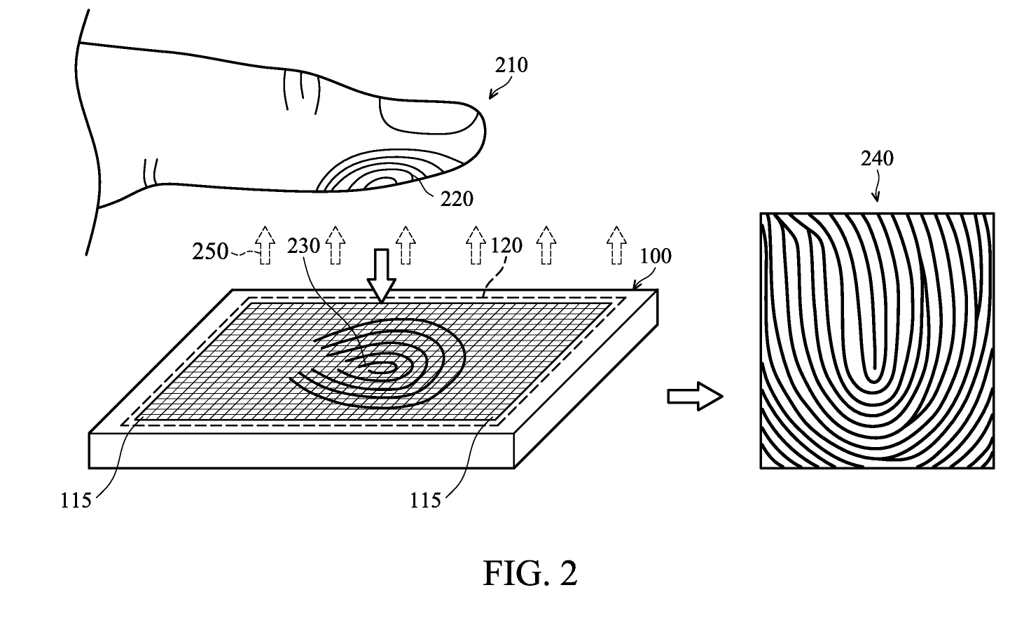

FIG. 2 shows a schematic diagram illustrating that the fingerprint sensor 100 of FIG. 1 is used to obtain the fingerprint of the user. In FIG. 2, when the finger 210 contacts the fingerprint sensor 100, the fingerprint ridges 220 on the surface of the finger 210 will contact and press the sensing units 115 via the insulating surface 120. Thus, in response to the transmitting signal S_{TX} coupled to the finger 210 (as shown in label 250), the fingerprint sensor 100 obtains a capacitance curve 230 corresponding to the fingerprint ridges 220, and identifies the shape of the fingerprint ridges 220 according to the shape of the capacitance curve 230, so as to obtain a fingerprint pattern 240. Next, the other circuits or devices can perform subsequent processes according to the fingerprint pattern 240.

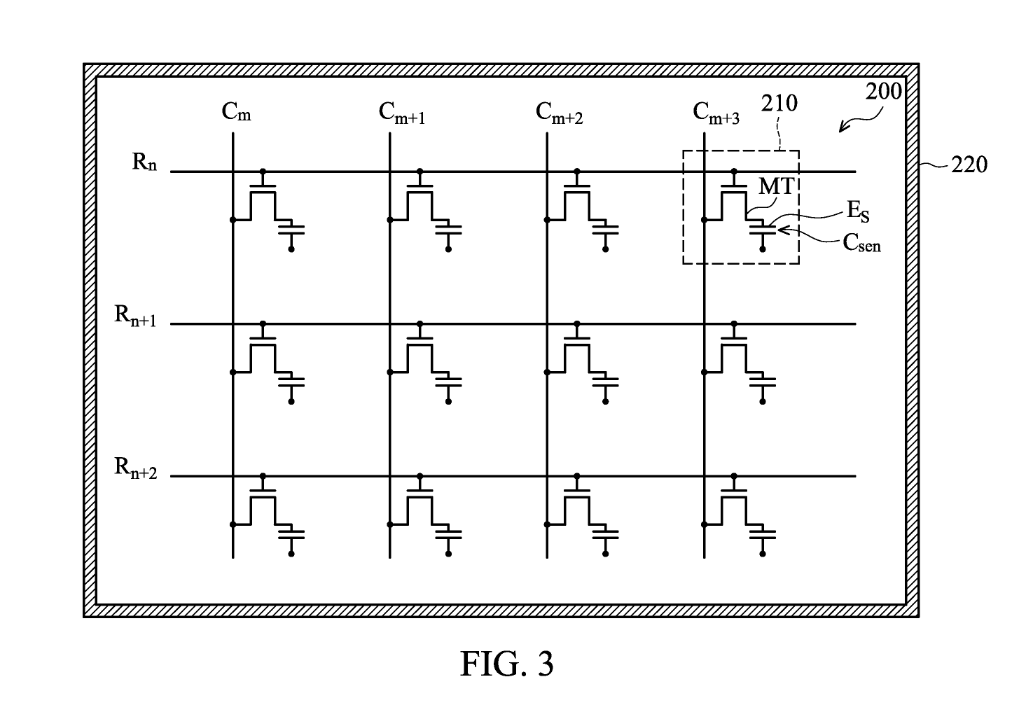

FIG. 3 shows a sensing array 200 according to an embodiment of the invention. In the sensing array 200, each sensing unit 210 comprises a thin-film transistor (TFT) MT and a sensing capacitor Cₛₑₙ. In FIG. 3, the thin-film transistors MT are arranged in a two-dimensional manner. In the embodiment, for each thin-film transistor MT, a gate of the thin-film transistor MT is coupled to the corresponding row line of the sensing array 200, such as Rₙ, Rₙ₊₁, Rₙ₊₂. A terminal of the thin-film transistor MT (e.g.

a source) is coupled to the corresponding column line, such as Cₘ, Cₘ₊₁, Cₘ₊₂, Cₘ₊₃, and another terminal of the thin-film transistor MT (e.g. a drain) is coupled to a sensing electrode Es, wherein the sensing electrode Es can form a sensing capacitor Cₛₑₙ between the another terminal of the thin-film transistor MT and a user's finger. In the sensing array 200, each row line can be addressed separately. In FIG. 3, a transmitting electrode 220 is formed by a metal ring surrounding the sensing array 200, wherein the transmitting electrode 220 is driven by the transmitting signal S_{TX}, and the transmitting signal S_{TX} is provided by the signal generator 130 of FIG. 1. It should be noted that the high frequency transmitting signal S_{TX} provided by the transmitting electrode 220 is first transmitted to the finger of the user, and the sensing electrode Es can sense the coupled transmitting signal S_{TX} from the user's finger to obtain a coupling value of the transmitting signal S_{TX}.

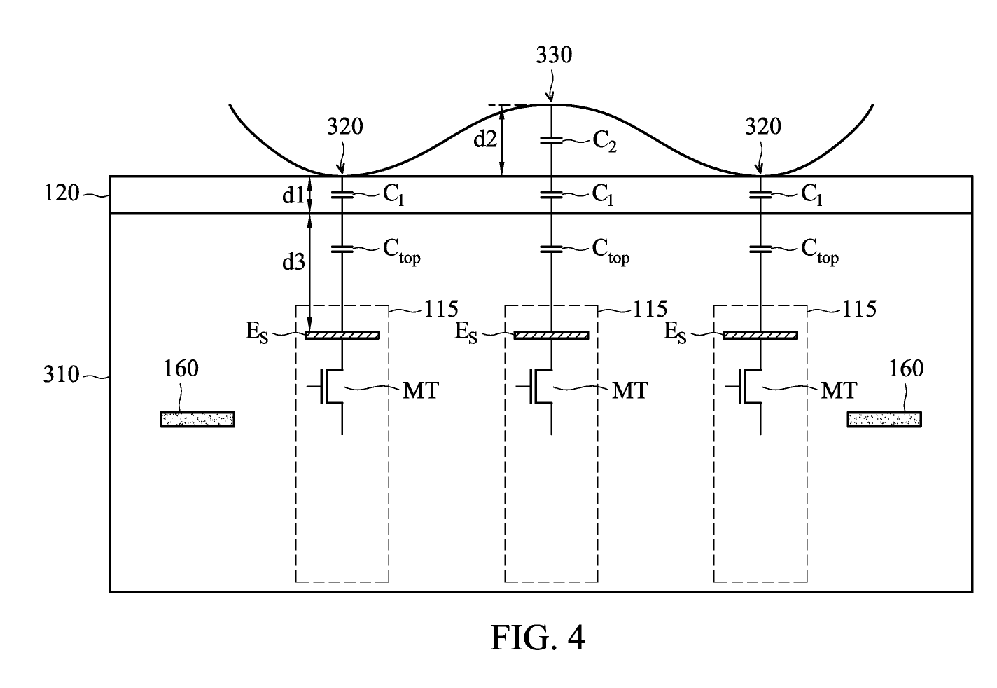

FIG. 4 shows a sectional schematic illustrating the finger of the user contacting the fingerprint sensor 100 of FIG. 1, wherein the transmitting electrode 160 of the fingerprint sensor 100 is formed by a metal ring surrounding the sensing array 100, such as transmitting electrode 220 of the FIG. 3, and the transmitting electrode 160 is laterally separated from the sensing array 110. In FIG. 4, the insulating surface 120 is disposed on the semiconductor substrate 310. In general, the insulating surface 120 is a protective dielectric layer formed by performing the integrated circuit manufacturing process. The thickness of the insulating surface 120 is d1, wherein an equivalent capacitor C₁ of the insulating surface 120 is determined by the thickness d1. Label 320 represents a fingerprint ridge of the finger, wherein the fingerprint ridge 320 of the finger will directly contact the insulating surface 120. Moreover, Label 330 represents a fingerprint valley of the finger, wherein the distance between the fingerprint valley 330 of the finger and the insulating surface 120 is d2, and a capacitor C₂ between the fingerprint valley 330 and insulating surface 120 is determined by the distance d2. As described above, the sensing array 110 is formed by a plurality of sensing units 115. Each sensing unit 115 comprises a sensing electrode Es and a thin-film transistor MT, wherein the sensing electrode Es is formed by a top metal layer and is disposed below the insulating surface 120. The thickness of an insulation layer between the insulating surface 120 and the sensing electrode Es is d3, wherein an equivalent capacitor Cₜₒₚ on the insulation layer is determined according to the thickness d3. Therefore, when the fingerprint ridge 320 contacts the insulating surface 120, a sensing capacitor Cₛₑₙ between the fingerprint ridge 320 and the sensing electrode Es is formed by the capacitor Cₜₒₚ and the capacitor C₁ connected in series. Furthermore, compared with the sensing capacitor Cₛₑₙ of the fingerprint ridge 320, a sensing capacitor Cₛₑₙ between the fingerprint valley 330 and the sensing electrode Es is formed by the capacitor Cₜₒₚ, the capacitor C₁ and the capacitor C₂ connected in series. Thus, when the finger contacts the insulating surface 120, the fingerprint ridge 320 and the fingerprint valley 330 will cause different capacitances, wherein the sensing capacitor Cₛₑₙ corresponding to the fingerprint valley 330 is smaller than the sensing capacitor Cₛₑₙ corresponding to the fingerprint ridge 320. Therefore, when the thin-film transistor MT is turned on, the readout module 140 of FIG. 1 can obtain the sensing voltage Vₛₑₙ corresponding to the sensing capacitor Cₛₑₙ via the sensing electrode Es of the sensing unit 115. Moreover, in the sensing unit 115, the thin-film transistor MT is disposed below the sensing electrode Es. Furthermore, the gate, drain, and source of the thin-film transistor MT are formed by the metal layer disposed below the sensing electrode Es. It should be noted that the row lines and the column lines of the sensing array 110 are disposed lower than the sensing electrode Es, and the row lines and the column lines will not form the sensing capacitor Cₛₑₙ coupled to the user's finger, thereby decreasing the influence caused by the interference signal passing the column lines or the row lines.

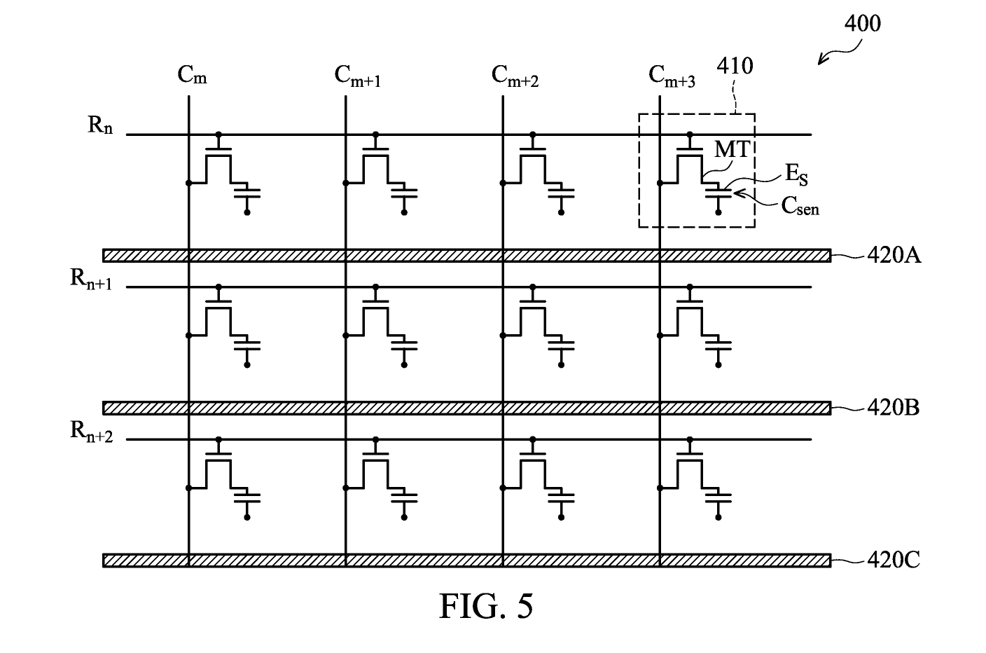

FIG. 5 shows a sensing array 400 according to another embodiment of the invention. In the sensing array 400, each sensing unit 410 comprises a thin-film transistor MT and a sensing capacitor Cₛₑₙ. As described above, the thin-film transistors MT are arranged in a two-dimensional manner, wherein the gate of each thin-film transistor MT is coupled to the corresponding row line of the sensing array 400. In the sensing array 400, each row line can be addressed separately. In FIG. 5, a plurality of transmitting electrodes 420A-420C are formed in the sensing array 400, wherein each transmitting electrode is disposed between two neighboring row lines, i.e. the transmitting electrodes 420A-420C are laterally spaced in the sensing array 400. For example, the transmitting electrode 420A is formed by a metal layer parallel to the row line Rₙ₊₁, and is disposed between the sensing units 410 corresponding to the row line Rₙ and the sensing units 410 corresponding to the row line Rₙ₊₁. Moreover, the transmitting electrode 420B is formed by a metal layer parallel to the row line Rₙ₊₂, and is disposed between the sensing units 410 corresponding to the row line Rₙ₊₁ and the sensing units 410 corresponding to the row line Rₙ₊₂. In the embodiment, the transmitting electrodes 420A-420C are driven by the transmitting signal S_{TX} provided by the signal generator 130 of FIG. 1, respectively.

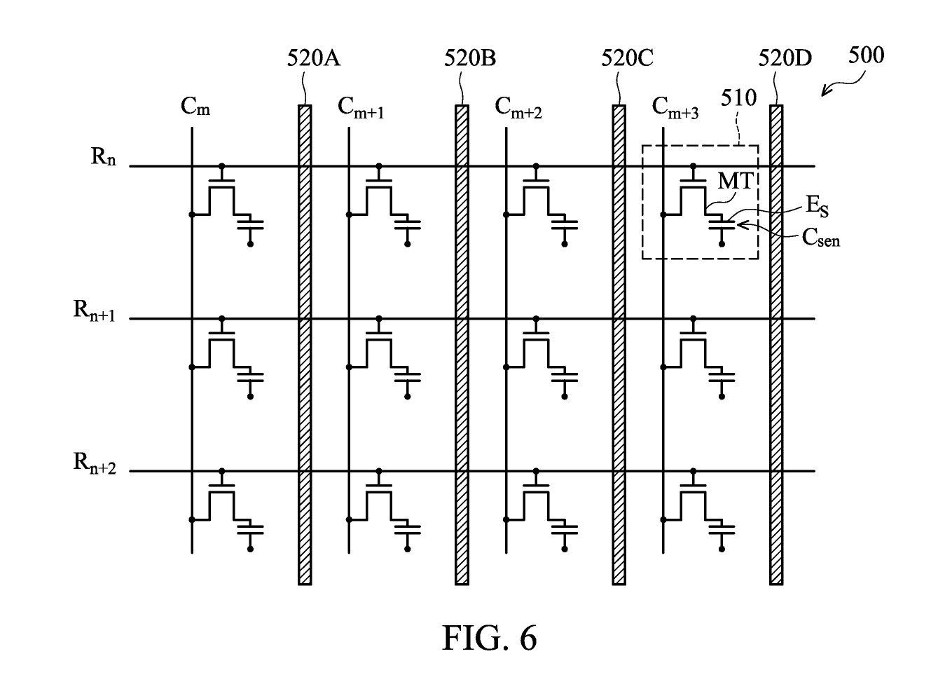

FIG. 6 shows a sensing array 500 according to another embodiment of the invention. In the sensing array 500, each sensing unit 510 comprises a thin-film transistor MT and a sensing capacitor Cₛₑₙ. As described above, the thin-film transistor MT are arranged in a two-dimensional manner, wherein the gate of each thin-film transistor MT is coupled to the corresponding row line of the sensing array 500, and each row line can be addressed separately. In FIG. 6, a plurality of transmitting electrodes 520A-520D are formed in the sensing array 500, wherein each transmitting electrode is disposed between two neighboring column lines, i.e. the transmitting electrodes 520A-520D are vertically spaced in the sensing array 500. For example, the transmitting electrode 520A is formed by a metal layer parallel to the column line Cₘ₊₁, and is disposed between the sensing units 510 corresponding to the column line Cₘ and the sensing units 510 corresponding to the column line Cₘ₊₁. Furthermore, the transmitting electrode 520B is formed by a metal layer parallel to the column line Cₘ₊₂, and is disposed between the sensing units 510 corresponding to the column line Cₘ₊₁ and the sensing units 510 corresponding to the column line Cₘ₊₂. Moreover, the transmitting electrode 520C is formed by a metal layer parallel to the column line Cₘ₊₃, and is disposed between the sensing units 510 corresponding to the column line Cₘ₊₂ and the sensing units 510 corresponding to the column line Cₘ₊₃. In the embodiment, the transmitting electrodes 520A-520D are driven by the transmitting signal S_{TX} provided by the signal generator 130 of FIG. 1.

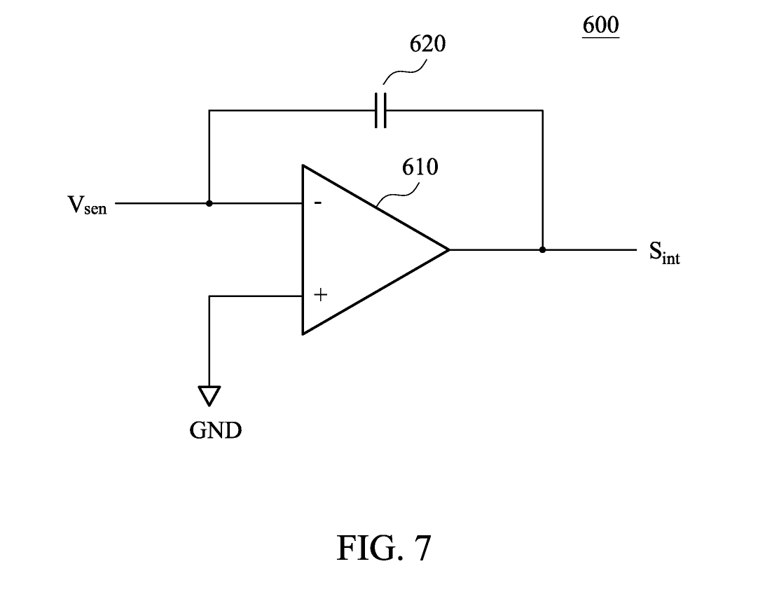

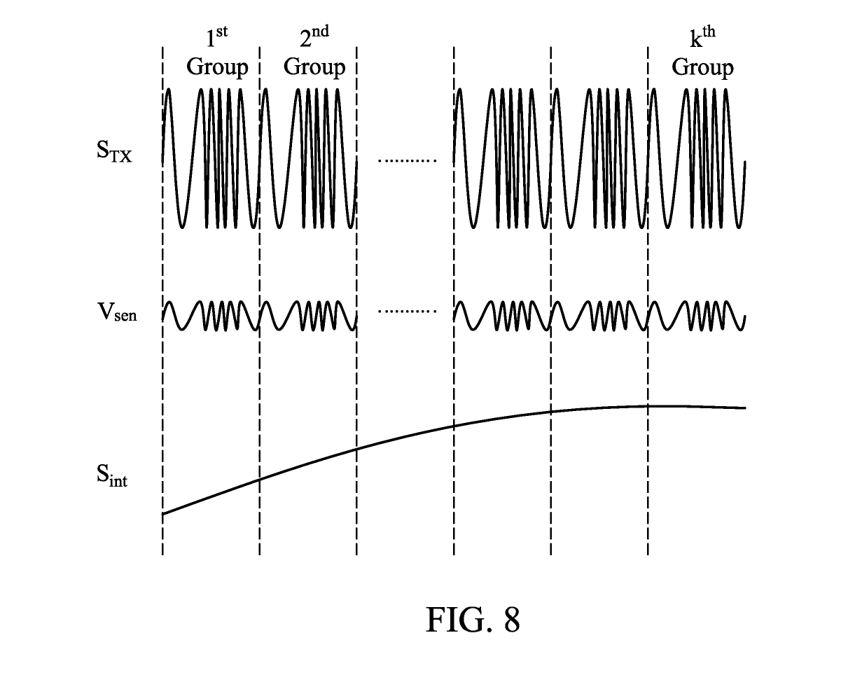

FIG. 7 shows a signal processing unit 600 according to an embodiment of the invention. In the embodiment, the signal processing unit 600 is an integrator capable of integrating the sensing voltage Vₛₑₙ and generating an integration signal Sᵢₙₜ, wherein the signal processing unit 600 comprises an amplifier 610 and a capacitor 620. An inverting input terminal of the amplifier 610 is coupled to the sensing unit to be sensed, and is used to receive the sensing voltage Vₛₑₙ. A non-inverting input terminal of the amplifier 610 is coupled to a ground GND. The capacitor 620 is coupled between the inverting input terminal and an output terminal of the amplifier 610. FIG. 8 shows a signal waveform of the signal processing unit 600 of FIG. 7. Referring to FIG. 1, FIG. 7 and FIG. 8 together, in the fingerprint sensor 100, the signal processing unit 145 of the readout module 140 is an integrator (e.g. the signal processing unit 600 of FIG. 7), and the signal generator 130 sequentially provides a plurality of groups of transmitting signals S_{TX} to drive the transmitting electrode 160, wherein each group of transmitting signals S_{TX} may be the modulation signals or pulse signals. In FIG. 8, the transmitting signals S_{TX} are FM signals. In the embodiment, the signal generator 130 sequentially provides k groups of transmitting signals S_{TX} to drive the transmitting electrode 160. In response to each group of transmitting signals S_{TX}, the sensing unit 115 to be sensed in the sensing array 110 can obtain the corresponding sensing voltage Vₛₑₙ. Next, the signal processing unit 600 of FIG. 7 can integrate the sensing voltage Vₛₑₙ to obtain an integration signal Sᵢₙₜ. Thus, the readout module 140 can provide the sensing output Dₛₑₙ according to the integration signal Sᵢₙₜ. Therefore, when the fingerprint sensor 100 is in a noisy environment and the sensing unit 115 can only obtain the smaller sensing voltage Vₛₑₙ, the fingerprint sensor 100 can sequentially provide multiple groups of transmitting signals S_{TX}, and integrate the sensing voltage Vₛₑₙ, so as to increase the signal strength of the sensing output Dₛₑₙ.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A fingerprint sensor for sensing fingerprint information of a user, comprising:
a sensing array, comprising a plurality of sensing units disposed in a plurality of row lines and a plurality of column lines, wherein each of the sensing units comprises a sensing electrode;
an insulating surface disposed on the sensing array;
at least one transmitting electrode, transmitting a modulating signal;
a readout module, obtaining a sensing voltage corresponding to the modulating signal coupled to a finger of the user via the sensing electrode of the sensing unit when the user places the finger on the insulating surface and the modulating signal transmitted by the transmitting electrode is coupled to the finger of the user; and
a processor, obtaining the fingerprint information according to the sensing voltage.

2. The fingerprint sensor as claimed in claim 1, wherein the transmitting electrode is formed by a ring surrounding the sensing array.

3. The fingerprint sensor as claimed in claim 1, wherein the transmitting electrode is parallel to and disposed between the sensing units of the two neighboring column lines.

4. The fingerprint sensor as claimed in claim 1, wherein the transmitting electrode is parallel to and disposed between the sensing units of the two neighboring row lines.

5. The fingerprint sensor as claimed in claim 1, further comprising:
a signal modulator, providing the modulating signal, wherein the modulating signal is a frequency modulation signal or an amplitude modulation signal.

6. The fingerprint sensor as claimed in claim 1, wherein the readout module comprises:
a filter, filtering the sensing voltage to obtain a coupling value of the modulating signal coupled to the finger of the user,
wherein the processor obtains the fingerprint information according to the filtered sensing voltage.

7. The fingerprint sensor as claimed in claim 1, wherein each of the sensing units further comprises a thin-film transistor, and the readout module obtains the sensing voltage from the sensing electrode via the thin-film transistor of the sensing unit.

8. The fingerprint sensor as claimed in claim 1, wherein the transmitting electrode sequentially transmits a plurality of groups of modulating signals, and the readout module obtains the sensing voltage corresponding to each group of modulating signals.

9. The fingerprint sensor as claimed in claim 8, wherein the readout module comprises:
an integrator, integrating the sensing voltage corresponding to each group of modulating signals to obtain an integration signal.

10. A sensing method for a fingerprint sensor, wherein the fingerprint sensor comprises a sensing array and an insulating surface disposed on the sensing array, and the sensing array comprises a plurality of sensing units disposed in a plurality of row lines and a plurality of column lines, and each of the sensing units comprises a sensing electrode, the method comprising:
transmitting a modulating signal via at least one transmitting electrode of the fingerprint sensor;
obtaining a sensing voltage corresponding to the modulating signal coupled to a finger of a user via the sensing electrode of the sensing unit when the user places the finger on the insulating surface and the modulating signal transmitted by the transmitting electrode is coupled to the finger of the user; and
obtaining fingerprint information according to the sensing voltage.

11. The sensing method as claimed in claim 10, wherein the transmitting electrode is formed by a ring surrounding the sensing array.

12. The sensing method as claimed in claim 10, wherein the transmitting electrode is parallel to and disposed between the sensing units of the two neighboring column lines.

13. The sensing method as claimed in claim 10, wherein the transmitting electrode is parallel to and disposed between the sensing units of the two neighboring row lines.

14. The sensing method as claimed in claim 10, wherein the modulating signal is provided by a signal modulator of the fingerprint sensor, wherein the modulating signal is a frequency modulation signal or an amplitude modulation signal.

15. The sensing method as claimed in claim 10, wherein the step of obtaining the fingerprint information according to the sensing voltage further comprises:
filtering the sensing voltage by a filter, so as to obtain a coupling value of the modulating signal coupled to the finger of the user; and
obtaining the fingerprint information according to the filtered sensing voltage.

16. The sensing method as claimed in claim 10, wherein each of the sensing units further comprises a thin-film transistor, and the sensing voltage from the sensing electrode is obtained via the thin-film transistor of the sensing unit.

17. The sensing method as claimed in claim 10, wherein the step of transmitting the modulating signal via the transmitting electrode of the fingerprint sensor further comprises:
sequentially transmitting a plurality of groups of the modulating signals via the transmitting electrode,
wherein the step of obtaining the sensing voltage further comprises:
obtaining the sensing voltage corresponding to each group of modulating signals coupled to the finger of the user via the sensing electrode of the sensing unit.

18. The sensing method as claimed in claim 17, wherein the step of obtaining the fingerprint information according to the sensing voltage further comprises:
integrating the sensing voltage corresponding to each group of modulating signals to obtain an integrated signal, by an integrator; and
obtaining the fingerprint information of the finger according to the integrated signal.
